(19) United States
(12) Patent Application Publication
(10) Pub. No.: US 2014/0200943 A1
(43) Pub. Date: Jul. 17, 2014

(54) ELECTRONIC CALENDAR SCHEDULING

(71) Applicant: INTERNATIONAL BUSINESS MACHINES CORPORATION, Armonk, NY (US)

(72) Inventors: Barbara Febonio, Rome (IT); Sandro Piccinini, Rome (IT); Stefano Sidoti, Rome (IT)

(73) Assignee: International Business Machines Corporation, Armonk, NY (US)

(21) Appl. No.: 13/740,477

(22) Filed: Jan. 14, 2013

(51) Int. Cl. G06Q 10/10

(52) U.S. Cl. CPC G06Q 10/1095
USPC 705/7.19

(57) ABSTRACT

A computer sends a binary representation of a request for a meeting to end-users. The computer generates one or more lists, wherein each of the lists includes electronic calendar time slots during which at least one of the plurality of end-users is able to attend the meeting. The computer identifies at least one electronic calendar time slot having a highest frequency of occurrence on the lists generated, which comprises iterating through each of the lists and computing a frequency of occurrence of the at least one electronic calendar time slot on the lists. The computer records the frequency of occurrence. The computer queues the meeting in response to the frequency of occurrence being less than a configurable threshold value. The computer schedules the meeting in response to the frequency of occurrence being equal to or greater than the configurable threshold value.

### BACKGROUND

1. Field of the Invention

The present invention relates generally to calendar management software, and more particularly to electronic calendar scheduling.

2. Description of the Related Art

Oftentimes, people are occupied with various meetings that are in progress or scheduled to occur in the future. It is known for people to utilize an electronic calendar to schedule and manage meetings, but it can be difficult for people to schedule a meeting in situations where persons that are required to or want to participate in the meeting have their electronic calendar booked with many other meetings. For example, a person invited to a meeting at a specified time may have only a few available electronic calendar time slots to attend the meeting, and other persons invited to the meeting may have different time slots available to attend the meeting. Thus, at the time the meeting is scheduled it may not be possible to find an electronic calendar time slot during which all persons invited to the meeting are available to attend. However, at a subsequent point in time the electronic calendar of one or more of the persons may change in a way such that an electronic calendar time slot arises in which all the persons are available to attend the meeting. Current, calendar management software may not be able to identify the change has occurred, wherein the change results in an electronic calendar time slot during which all the persons invited to the meeting can attend.

### SUMMARY

Aspects of an embodiment of the present invention disclose a method, computer system, and program product for scheduling a meeting. The computer sends a binary representation of a request for a meeting to a plurality of end-users on one or more computers, wherein each of the plurality of end-users has a configurable profile. The computer generates one or more lists each associated to at least one of the plurality of end-users, wherein each of the lists includes available time slots during which at least one of the plurality of end-users is able to attend the meeting. The computer identifies at least one time slot having a highest frequency of occurrence on the one or more lists generated, wherein the identifying comprises iterating through each of the one or more lists and computing a frequency of occurrence of the at least one time slot on the one or more lists. The computer records the frequency of occurrence of the at least one time slot on the one or more lists. The computer queues the meeting in response to the frequency of occurrence of the at least one time slot being less than a configurable threshold value that represents a level at which the meeting is to be scheduled if the frequency of occurrence of the at least one time slot equals to or exceeds the level. The computer schedules the meeting in response to the frequency of occurrence being equal to or greater than the configurable threshold value.

### BRIEF DESCRIPTION OF THE SEVERAL VIEWS OF THE DRAWINGS

The subject matter which is regarded as an embodiment of the present invention is particularly pointed out and distinctly claimed in the claims at the conclusion of the specification. One manner in which recited features of an embodiment of the present invention can be understood is by reference to the following detailed description of embodiments, taken in conjunction with the accompanying drawings in which:

FIG. 1 is a block diagram of a computer system having client computers utilizing an electronic calendar management program to monitor electronic calendars of end-users invited to a meeting, and schedule the meeting in response to at least one of the end-users having an available electronic calendar time slot during which they can attend the meeting according to an embodiment of the present invention.

FIGS. 2A and 2B are flowcharts illustrating operations of the electronic calendar management program according to an embodiment of the present invention.

FIG. 3 is a block diagram depicting internal and external components of the client computers of FIG. 1 according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like, conventional procedural programming languages such as the “C” programming language, a hardware description language such as VERILOG, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Embodiments of the present invention provide an electronic calendar management program having a meeting scheduler program module. The electronic calendar management program is installed on one or more computers. The electronic calendar management program monitors electronic calendars of end-users invited to a meeting, and schedules the meeting in response to at least one of the end-users having an available electronic calendar time slot, including any other available time slot, during which to attend the meeting.

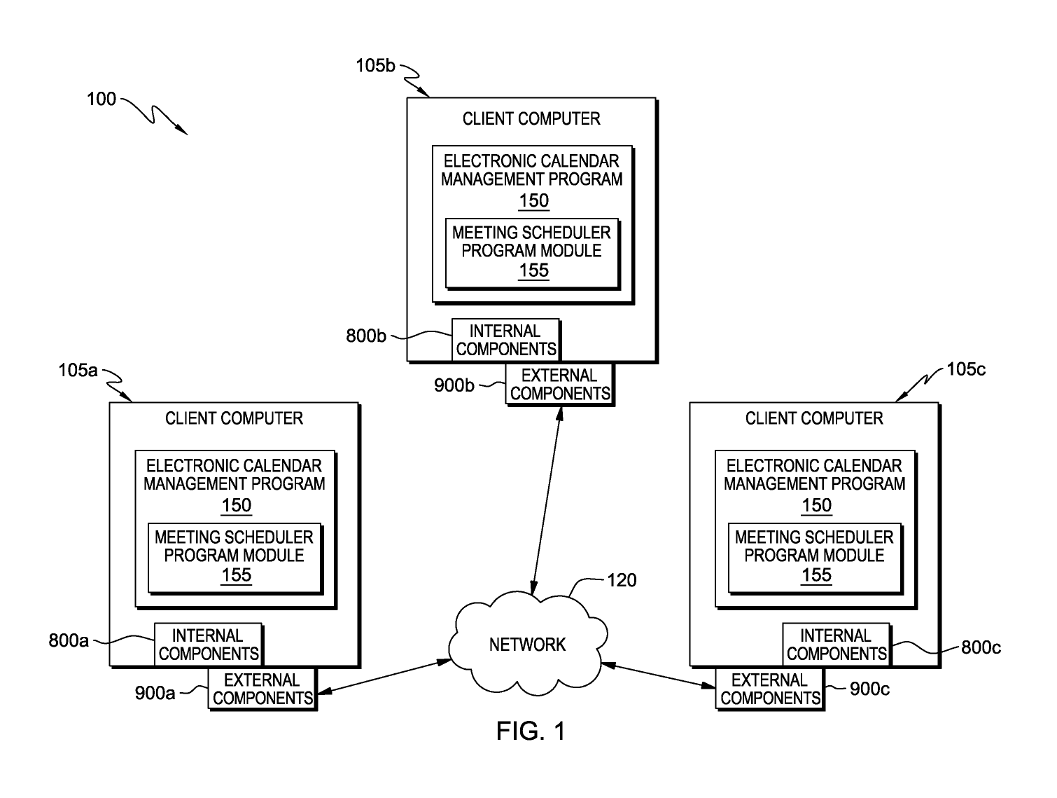

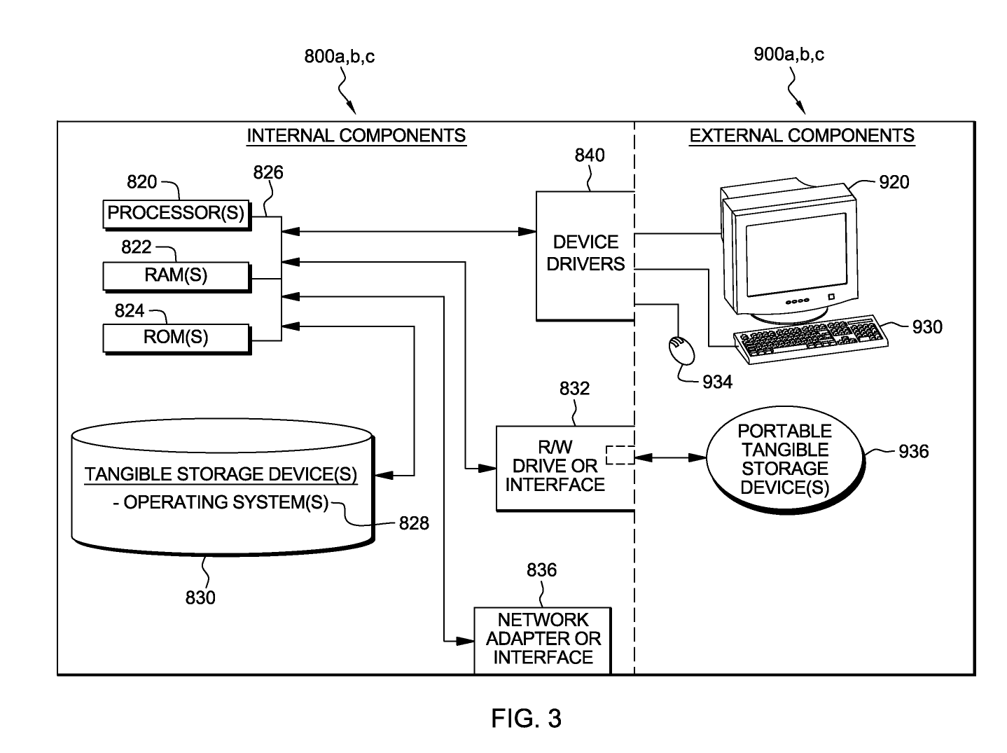

FIG. 1 illustrates computer system 100 that includes client computers 105a-105c each installed with electronic calendar management program 150 having program code that includes meeting scheduler program module 155. Electronic calendar management program 150 includes calendar management functionality for configuring an end-user profile, queuing a binary representation of a request for a meeting, generating a list of electronic calendar time slots that are available for invitees to attend the meeting, scheduling the meeting during one of the electronic calendar time slots, and notifying the invitees about the scheduling of the meeting. Thus, electronic calendar management program 150 can manage electronic calendars of end-users that are invited to a meeting by monitoring each of the end-users electronic calendars for one or more available electronic calendar time slots during which at least one of the end-users can attend the meeting. If electronic calendar management program 150 identifies one or more available electronic calendar time slots during which at least one of the end-users can attend the meeting, then meeting scheduler program module 155 can adjust the calendar entries of one or more of the end-users and schedule the meeting during at least one of the available electronic calendar time slots identified. In addition, client computers 105a, 105b, and 105c each include respective internal components 800a, 800b, and 800c, and respective external components 900a, 900b, and 900c. Internal components 800a-800c, and respective external components 900a-900c are described below in more detail with respect to FIG. 3.

In the disclosed embodiment, client computers 105a-105c are connected to each other through network 120 in a peer-to-peer computer network configuration. The peer-to-peer computer network configuration allows end-users of client computers 105a-105c to connect to each other's hard disks and directly transfer data between each other. However, in other embodiments client computers 105a-105c can be connected to a server computer via network 120 in a client-server computer network configuration, wherein each of client computers 105a-105c can request from the server computer electronic calendar management services that provide the calendar management functionality mentioned above. In the client-server computer network configuration the server computer controls access to hardware and software resources via network 120 and provides a centralized repository for data and information utilized and/or generated by electronic calendar management program 150.

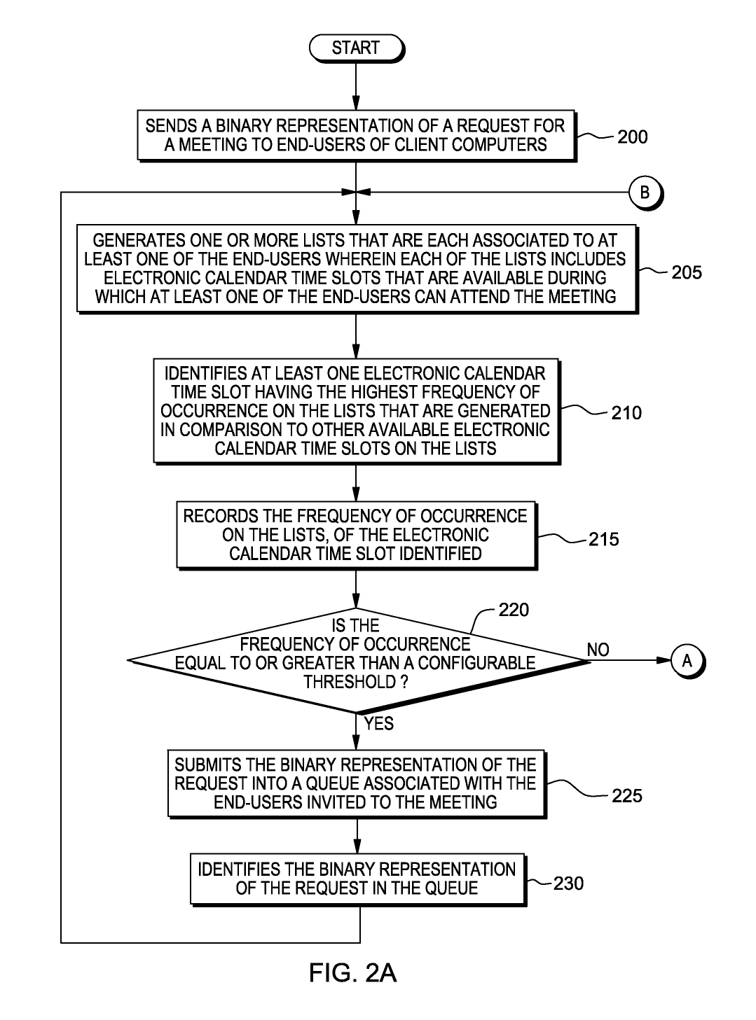

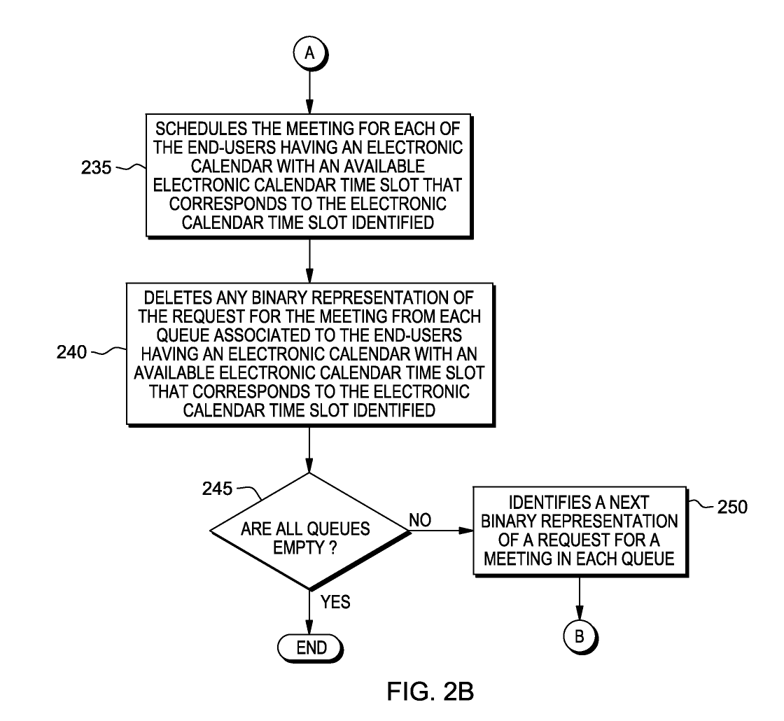

FIGS. 2A and 2B are flowcharts illustrating the steps of electronic calendar management program 150 for monitoring electronic calendars of end-users invited to a meeting, and scheduling the meeting in response to at least one of the end-users having an available electronic calendar time slot during which the end-user can attend the meeting. Each of the end-users have a configurable profile that can define at least one or more electronic calendar time slots during which the end-user prefers to have a meeting scheduled and define policies that specify a priority for handling binary representations of requests for meetings. In the disclosed embodiment, meeting scheduler program module 155 of client computer 105a sends a binary representation of a request for a meeting to end-users of client computers 105b or 105c (block 200). The binary representation of the request for the meeting defines attributes of the meeting including at least the following: a name of a requester of the meeting, a time duration requested for the meeting, a location of the meeting, a list of required invitees to the meeting, and a list of optional invitees to the meeting.

In response to client computers 105b and 105c receiving the binary representation of the request, the program code generates one or more lists each associated to at least one of the end-users wherein each of the lists includes electronic calendar time slots available during which at least one of the end-users invited to the meeting can attend the meeting (block 205). Specifically to generate the one or more lists the program code searches the electronic calendars of each of the end-users for electronic calendar time slots during which the end-users are available, and for each end-user enters a copy of those electronic calendar time slots onto one of the one or more lists corresponding to the appropriate end-user.

Next, the program code identifies at least one electronic calendar time slot having the highest frequency of occurrence on the lists that are generated in comparison to other available electronic calendar time slots on the lists (block 210). However, if more than one electronic calendar time slot is identified, then the program code selects the electronic calendar time slot that matches with the highest frequency of electronic calendar time slots defined in each end-user's configurable profile as electronic calendar time slots during which the end-user prefers to have a meeting scheduled. Specifically, to identify the electronic calendar time slot having the highest frequency of occurrence on the lists, the program code iterates through each of the lists and computes a frequency of occurrence of each electronic calendar time slot on the lists. The electronic calendar time slot with the highest frequency of occurrence is on the greatest number of lists. In addition, in order to identify the electronic calendar time slot that matches with the highest frequency of electronic calendar time slots the end-users defined in each of their configurable profiles, the program code iterates through each of the lists and computes a number of matches between each of the electronic calendar time slots on the lists and the electronic calendar time slots that the end-users defined in each of their configurable profiles. The electronic calendar time slot that is on the greatest number of lists and that matches with the highest frequency of electronic calendar time slots defined in each end-user's configurable profile, is recognized by the program code as a time period during which most of the end-users invited to the meeting can attend. Next, the program code records the frequency of occurrence on the lists, of the electronic calendar time slot identified (block 215).

If the frequency of occurrence is not equal to or greater than a configurable threshold value (the “YES” branch of decision block 220), then electronic calendar management program 150 submits the binary representation of the request into a queue associated with the end-users invited to the meeting (block 225). The threshold value represents a level at which the meeting is scheduled if the frequency of occurrence equals to or exceeds the level. Thus, each of the end-users invited to the meeting can possess a queue associated to the end-user, wherein each queue is utilized to manage pending requests, to the end-users, to attend a meeting in which there is no electronic calendar time slot currently available to attend the meeting. In the disclosed embodiment, the queue is defined as a linked list (i.e., data structure) on each computer (e.g., client computer 105b and client computer 105c) that stores the binary representation of the request. In response to a change in the electronic calendar of at least one of the end-users invited to attend the meeting, the program code of electronic calendar management program 150 identifies the binary representation of the request in the queue (block 230). In particular, the program code can sequentially identify the binary representation of the request in the queue as well as others in the queue based on a First-In-First-Out (FIFO) rule, Last-In-Last-Out (LIFO) rule, title of person requesting the meeting, level of importance of the person requesting the meeting to the end-users, or other priority rule as specified in policies that can be defined in each configurable profile of the end-users. For example, end-users' profiles can be configured to give highest priority to a binary representation of a request for a meeting that is received by the end-users from their managers.

Next, in order to determine whether an electronic calendar time slot has become available during which additional end-users invited to the meeting can attend the meeting, the program code generates one or more lists that are each associated to at least one of the end-users wherein each of the lists includes electronic calendar time slots that are available during which at least one of the end-users invited to the meeting can attend the meeting (block 205). Thus, the program code will continue until the meeting can be scheduled and each queue is empty.

However, if the amount of occurrence is equal to or greater than a configurable threshold value (the “NO” branch of decision block 220), then the program code schedules the meeting for each of the end-users having an electronic calendar with an available electronic calendar time slot that corresponds to the electronic calendar time slot identified (block 235). Specifically, the meeting is scheduled utilizing the attributes define by the binary representation of the request for the meeting. Next, the program code deletes any binary representation of the request for the meeting from each queue associated to the end-users having an electronic calendar with an available electronic calendar time slot that corresponds to the electronic calendar time slot identified (block 240).

If not all queues are empty (the “NO” branch of decision block 245), then the program code identifies a next binary representation of a request for a meeting in each queue (block 250). Subsequently, the program code generates one or more lists that are each associated to at least one of the end-users wherein each of the lists includes electronic calendar time slots that are available during which at least one of the end-users invited to the meeting, corresponding to the next binary representation, can attend the meeting (block 205). However, if all queues are empty (the “YES” branch of decision block 245), then the program code ends.

FIG. 3 is a block diagram depicting a set of internal components 800a-800c and a set of external components 900a-900c that correspond to respective client computers 105a-105c. Internal components 800a-800c each include one or more processors 820, one or more computer readable RAMs 822 and one or more computer readable ROMs 824 on one or more buses 826, and one or more operating systems 828 and one or more computer readable tangible storage devices 830. The one or more operating systems 828 and electronic calendar management program 150 on each client computer 105a-105c are stored on one or more of the respective computer readable tangible storage devices 830 for execution by one or more of the respective processors 820 via one or more of the respective RAMs 822 (which typically include cache memory). In the embodiment illustrated in FIG. 3, each of the computer readable tangible storage devices 830 is a magnetic disk storage device of an internal hard drive. Alternatively, each of the computer readable tangible storage devices 830 is a semiconductor storage device such as ROM 824, EPROM, flash memory or any other computer readable tangible storage device that can store a computer program and digital information.

Each set of internal components 800a-800c includes a R/W drive or interface 832 to read from and write to one or more portable computer readable tangible storage devices 936 such as CD-ROM, DVD, memory stick, magnetic tape, magnetic disk, optical disk or semiconductor storage device. Electronic calendar management program 150 on each client computer 105a-105c can be stored on one or more of the respective portable computer readable tangible storage devices 936, read via the respective R/W drive or interface 832 and loaded into the respective hard drive or computer readable tangible storage device 830.

Furthermore, each set of internal components 800a-800c also includes a network adapter or interface 836 such as TCP/IP adapter card, wireless wi-fi interface card, or 3G or 4G wireless interface card or other wired or wireless communication link. Electronic calendar management program 150 on each client computer 105a-105c can be downloaded to respective client computers 105a-105c from an external computer or external storage device via a network (for example, the Internet, a LAN, or a WAN) and respective network adapters or interfaces 836. From the network adapter or interface 836, electronic calendar management program 150 on each client computer 105a-105c is loaded into at least one respective hard drive or computer readable tangible storage device 830. The network may comprise copper wires, optical fibers, wireless transmission, routers, firewalls, switches, gateway computers and/or servers.

Each set of external components 900a-900c can include a computer display monitor 920, a keyboard 930, and a computer mouse 934. External components 900a-900c can also include touch screens, virtual keyboards, touch pads, pointing devices, and other human interface devices. Each set of internal components 800a-800c also includes device drivers 840 to interface to computer display monitor 920, keyboard 930 and computer mouse 934. The device drivers 840, R/W drive or interface 832 and network adapter or interface 836 comprise hardware and software in which the software is stored in computer readable tangible storage device 830 and/or ROM 824.

It should be appreciated that FIG. 3 provides only an illustration of one implementation and does not imply any limitations with regard to the environments in which different embodiments may be implemented. A variety of modifications to the depicted environments may be implemented. Moreover, a variety of modifications to the depicted environments may be made based on design and implementation requirements.

In accordance with the foregoing, a method, a computer system, and a computer program product have been disclosed for monitoring electronic calendars of end-users invited to a meeting, and scheduling the meeting in response to at least one of the end-users having an available electronic calendar time slot on their electronic calendar during which they can attend the meeting. However, numerous modifications and substitutions can be made without deviating from the scope of an embodiment of the invention. Therefore, one or more embodiments of the invention have been disclosed by way of example and not limitation.

What is claimed is:

1. A method for scheduling a meeting, the method comprising the steps of:
sending a binary representation of a request for a meeting to a plurality of end-users on one or more computers, wherein each of the plurality of end-users has a configurable profile;
generating one or more lists each associated to at least one of the plurality of end-users, wherein each of the lists includes available time slots during which at least one of the plurality of end-users is able to attend the meeting;
identifying at least one time slot having a highest frequency of occurrence on the one or more lists generated, wherein the identifying comprises iterating through each of the one or more lists and computing a frequency of occurrence of the at least one time slot on the one or more lists;
recording the frequency of occurrence of the at least one time slot on the one or more lists;
queuing the meeting in response to the frequency of occurrence of the at least one time slot being less than a configurable threshold value that represents a level at which the meeting is to be scheduled if the frequency of occurrence of the at least one time slot equals to or exceeds the level; and
scheduling the meeting in response to the frequency of occurrence being equal to or greater than the configurable threshold value.

2. The method of claim 1, wherein the binary representation in the sending step defines attributes of the meeting that include at least the following: a name of a requester of the meeting, a time duration requested for the meeting, a location of the meeting, a list of required invitees to the meeting, and a list of optional invitees to the meeting.

3. The method of claim 1, wherein the configurable profile in the sending step defines at least one or more time slots during which the end-user prefers to have a meeting scheduled and defines policies specifying a priority for handling binary representations of requests for meetings.

4. The method of claim 3, wherein the policies specifying the priority are based on a First-In-First-Out (FIFO) rule, a Last-In-Last-Out (LIFO) rule, title of a person requesting the meeting, or level of importance, to the end-users, of the person requesting the meeting.

5. The method of claim 1, wherein the step of generating the one or more lists comprises:
searching electronic calendars of each of the plurality of end-users for available time slots during which each of the end-users is able to attend the meeting; and
entering a copy of the available time slots onto one of the one or more lists corresponding to the one or more of the plurality of end-users.

6. The method of claim 1, wherein the step of identifying the time slot comprises computing a number of matches between each of the time slots on the lists and the time slots that the end-users defined in each of their configurable profiles, if more than one time slot is identified.

7. The method of claim 1, wherein the step of queuing the meeting comprises defining a linked list to store the binary representation of the request for the meeting.

8. A computer program product for scheduling a meeting, the computer program product comprising:
a computer readable storage medium and program instructions stored on the computer readable storage medium, the program instructions comprising:
program instructions to send a binary representation of a request for a meeting to a plurality of end-users on one or more computers, wherein each of the plurality of end-users has a configurable profile;
program instructions to generate one or more lists each associated to at least one of the plurality of end-users, wherein each of the lists includes available time slots during which at least one of the plurality of end-users is able to attend the meeting;
program instructions to identify at least one time slot having a highest frequency of occurrence on the one or more lists generated, wherein the program instructions to identify comprises iterating through each of the one or more lists and computing a frequency of occurrence of the at least one time slot on the one or more lists;
program instructions to record the frequency of occurrence of the at least one time slot on the one or more lists;
program instructions to queue the meeting in response to the frequency of occurrence of the at least one time slot being less than a configurable threshold value that represents a level at which the meeting is to be scheduled if the frequency of occurrence of the at least one time slot equals to or exceeds the level; and
program instructions to schedule the meeting in response to the frequency of occurrence being equal to or greater than the configurable threshold value.

9. The computer program product of claim 8, wherein the binary representation defines attributes of the meeting that include at least the following: a name of a requester of the meeting, a time duration requested for the meeting, a location of the meeting, a list of required invitees to the meeting, and a list of optional invitees to the meeting.

10. The computer program product of claim 8, wherein the configurable profile defines at least one or more time slots during which the end-user prefers to have a meeting scheduled and defines policies specifying a priority for handling binary representations of requests for meetings.

11. The computer program product of claim 10, wherein the policies specifying the priority are based on a First-In-First-Out (FIFO) rule, a Last-In-Last-Out (LIFO) rule, title of a person requesting the meeting, or level of importance, to the end-users, of the person requesting the meeting.

12. The computer program product of claim 8, wherein the program instructions to generate the one or more lists comprises:
program instructions to search electronic calendars of each of the plurality of end-users for available time slots during which each of the end-users is able to attend the meeting; and
program instructions to enter a copy of the available time slots onto one of the one or more lists corresponding to the one or more of the plurality of end-users.

13. The computer program product of claim 8, wherein the program instructions to identify the time slot comprises program instructions to compute a number of matches between each of the time slots on the lists and the time slots that the end-users defined in each of their configurable profiles, if more than one time slot is identified.

14. The computer program product of claim 8, wherein the step of queuing the meeting comprises defining a linked list to store the binary representation of the request for the meeting.

15. A computer system for scheduling a meeting, the computer system comprising:
one or more processors, one or more computer readable memories, one or more computer readable storage media, and program instructions stored on the one or more storage media for execution by the one or more processors via the one or more memories, the program instructions comprising:
program instructions to send a binary representation of a request for a meeting to a plurality of end-users on one or more computers, wherein each of the plurality of end-users has a configurable profile;
program instructions to generate one or more lists each associated to at least one of the plurality of end-users, wherein each of the lists includes available time slots during which at least one of the plurality of end-users is able to attend the meeting;
program instructions to identify at least one time slot having a highest frequency of occurrence on the one or more lists generated, wherein the program instructions to identify comprises iterating through each of the one or more lists and computing a frequency of occurrence of the at least one time slot on the one or more lists;
program instructions to record the frequency of occurrence of the at least one time slot on the one or more lists;
program instructions to queue the meeting in response to the frequency of occurrence of the at least one time slot being less than a configurable threshold value that represents a level at which the meeting is to be scheduled if the frequency of occurrence of the at least one time slot equals to or exceeds the level; and
program instructions to schedule the meeting in response to the frequency of occurrence being equal to or greater than the configurable threshold value.

16. The computer system of claim 15, wherein the binary representation defines attributes of the meeting that include at least the following: a name of a requester of the meeting, a time duration requested for the meeting, a location of the meeting, a list of required invitees to the meeting, and a list of optional invitees to the meeting.

17. The computer system of claim 15, wherein the configurable profile defines at least one or more time slots during which the end-user prefers to have a meeting scheduled and defines policies specifying a priority for handling binary representations of requests for meetings.

18. The computer system of claim 17, wherein the policies specifying the priority are based on a First-In-First-Out (FIFO) rule, a Last-In-Last-Out (LIFO) rule, title of a person requesting the meeting, or level of importance, to the end-users, of the person requesting the meeting.

19. The computer system of claim 15, wherein the program instructions to generate the one or more lists comprises:
program instructions to search electronic calendars of each of the plurality of end-users for available time slots during which each of the end-users is able to attend the meeting; and
program instructions to enter a copy of the available time slots onto one of the one or more lists corresponding to the one or more of the plurality of end-users.

20. The computer system of claim 15, wherein the program instructions to identify the time slot comprises program instructions to compute a number of matches between each of the time slots on the lists and the time slots that the end-users defined in each of their configurable profiles, if more than one time slot is identified.

21. The computer system of claim 15, wherein the step of queuing the meeting comprises defining a linked list to store the binary representation of the request for the meeting.
